(19) United States
(12) Patent Application Publication
(10) Pub. No.: US 2011/0170076 A1
(43) Pub. Date: Jul. 14, 2011

(54) IMMERSION LITHOGRAPHY APPARATUS AND METHOD FOR CLEANING IMMERSION LITHOGRAPHY APPARATUS

(76) Inventor: Masaru SUZUKI, Mie-ken (JP)

(21) Appl. No.: 12/845,537

(22) Filed: Jul. 28, 2010

(30) Foreign Application Priority Data
Jan. 8, 2010 (JP) P2010-002762

(51) Int. Cl. G03B 27/52; B08B 7/04

(52) U.S. Cl. 355/30; 134/10

(57) ABSTRACT

In one embodiment, an immersion lithography apparatus has a substrate stage that holds a workpiece and is configured to be possible to take an exposure position under a light projection unit and to keep away from the position. A cleaning stage has a reservoir of a cleaning or immersion liquid, and is configured to be possible to take the exposure position by replacing the substrate stage. An immersion liquid supply system supplies the immersion liquid between the light projection unit and the workpiece or in the reservoir, and an immersion liquid recovery system recovers the immersion liquid. A cleaning liquid supply system supplies the cleaning liquid in the reservoir to include contact regions to the immersion liquid, and a cleaning liquid recovery system recovers the cleaning liquid. A concentration measuring instrument is installed on the immersion or cleaning liquid recovery system, and measures a concentration of the cleaning liquid.

### CROSS REFERENCE TO RELATED APPLICATION

This application is based upon and claims the benefit of priority from the prior Japanese Patent Application No. 2010-2762, filed on Jan. 8, 2010; the entire contents of which are incorporated herein by reference.

### FIELD

Embodiments described herein relate generally to an immersion lithography apparatus and a method for cleaning the immersion lithography apparatus.

### BACKGROUND

Along with miniaturization of a semiconductor device, a chance of manufacturing a device using an immersion lithography apparatus has been increasing. An immersion lithography apparatus has a configuration that a liquid (an immersion liquid) is filled between a light projection unit and an object of exposure (a resist film on a substrate or the like) and an exposing light is irradiated on the object of exposure through the immersion liquid. As the immersion liquid comes in contact with the object of exposure and the light projection unit and the like, there is a possibility that contaminants from the object of exposure and the like adhere to the light projection unit through the immersion liquid.

Consequently, it becomes necessary to remove the adhered contaminants. Japanese Patent application Publication No. 2008-252040 discloses, for example, that an immersion lithography apparatus is provided with an air bubble generating unit to generate air bubbles in a cleaning liquid supplied to the immersion lithography apparatus, a controller to control the air bubbles generated by the air bubble generating unit, and a particle monitor to obtain information of particles (contaminants) adhered to regions with which the immersion liquid of the immersion lithography apparatus contacts, and removes the adhered particles.

It is possible that the disclosed immersion lithography apparatus cleans until the particles are sufficiently removed based on information of the particles (contaminants) obtained by a laser irradiation. After the particles are removed to not more than a specified value, the cleaning liquid is tried to replace with the immersion liquid, but there is no disclosure of mention and suggestion with respect to what extent the replacement of a functional water such as an ozone water used as the cleaning liquid is performed. That is, there is a case that the immersion liquid including the cleaning liquid which remains without being sufficiently replaced dissolves more largely the object of exposure contacting to the immersion liquid, and as a result, the object of exposure becomes thinner, and in addition a problem still remains that more contaminants adhere to the regions which the immersion liquid has come in contact with. When the contaminants adhere to the light projection unit, a problem also generates that a mask pattern formed on a reticle is not transferred normally, so that the production yield of the semiconductor device is reduced.

### BRIEF DESCRIPTION OF THE DRAWINGS

FIG. 1 is a schematic view showing a configuration at the time of cleaning of an immersion lithography apparatus according to a first embodiment of the invention.

FIG. 2 is a flow chart showing a method for cleaning an immersion lithography apparatus according to the first embodiment.

FIG. 3 is a schematic view showing a configuration at the time of cleaning of an immersion lithography apparatus according to a second embodiment of the invention.

FIG. 4 is a schematic view showing a configuration at the time of cleaning of an immersion lithography apparatus according to a third embodiment of the invention.

FIG. 5 is a schematic view showing a configuration at the time of cleaning of an immersion lithography apparatus according to a forth embodiment of the invention.

### DETAILED DESCRIPTION

In one embodiment, an immersion lithography apparatus includes a substrate stage, a cleaning stage, an immersion liquid supply system, an immersion liquid recovery system, a cleaning liquid supply system, a cleaning liquid recovery system, and a concentration measuring instrument. The substrate stage that holds a workpiece is configured to be possible to take an exposure position under a bottom portion of a light projection unit in a vertical direction and to keep away from the exposure position under the light projection unit. The cleaning stage has a reservoir of a cleaning liquid or an immersion liquid in a top portion. The cleaning stage is configured to be possible to take the exposure position by replacing the substrate stage and to keep away from the exposure position. The immersion liquid supply system supplies the immersion liquid between the bottom portion of the light projection unit and the workpiece or in the reservoir, and the immersion liquid recovery system recovers the immersion liquid. The cleaning liquid supply system supplies the cleaning liquid in the reservoir to include contact regions to the immersion liquid, and the cleaning liquid recovery system recovers the cleaning liquid. The concentration measuring instrument is installed on the immersion liquid recovery system or the cleaning liquid recovery system, and measures a concentration of the cleaning liquid in the immersion liquid.

In one embodiment, a method for cleaning an immersion lithography apparatus is disclosed. The method can remove a substrate stage from an exposure position under a bottom portion of a light projection unit after exposing a workpiece between the light projection unit and the substrate stage through an immersion liquid. The method can arrange a cleaning stage in a cleaning position under the bottom portion of the light projection unit in a vertical direction and clean contact regions to the immersion liquid with a cleaning liquid running from a supply opening to a recovery opening on a reservoir in a top portion of the cleaning stage, where the reservoir can be supplied with the cleaning liquid to an extent that the contact regions is covered. The method can measure a concentration of the cleaning liquid in the immersion liquid or a water while the cleaning liquid is replaced with the immersion liquid or the water after the cleaning liquid is stopped, and lower the concentration to less than or equal to a specified value. The method can stop supplying the immersion liquid or the water after the concentration is lowered to less than or equal to the specified value and remove the cleaning stage from the cleaning position.

Hereinafter, embodiments of the invention will be described with reference to the drawings. In the drawings shown hereinafter, the same reference numerals are given for the same elements.

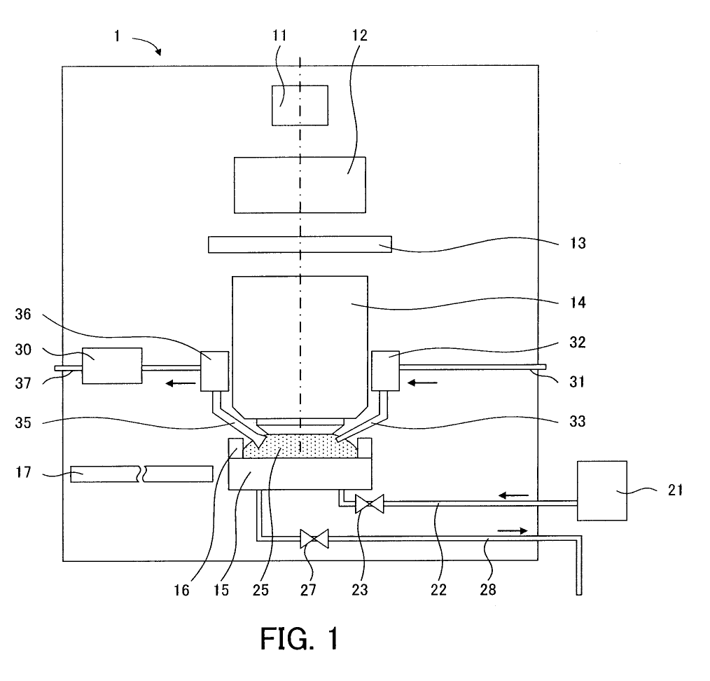

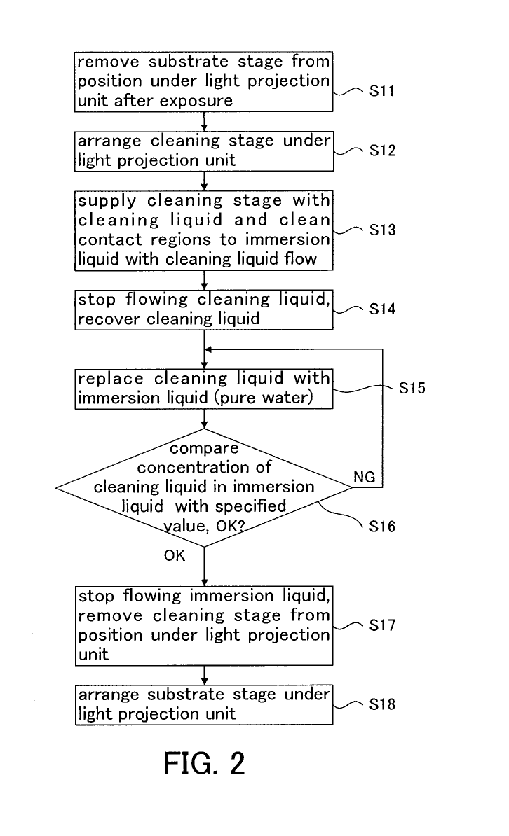

An immersion lithography apparatus and a method for cleaning the immersion lithography apparatus according to a first embodiment of the invention will be described with reference to FIG. 1 and FIG. 2.

As shown in FIG. 1, in an immersion lithography apparatus 1, a light source 11, an illuminator optical unit 12, a reticle stage 13, and a light projection unit 14 are arranged from top down along an optical axis (a chain line) which is in approximately parallel with a vertical line. In the immersion lithography apparatus 1, at the time of a cleaning, a cleaning stage 15 is arranged under the light projection unit 14 in a vertical direction, and a cleaning liquid 25 is filled in a gap between the cleaning stage 15 and a bottom portion (a lens) of the light projection unit 14. The cleaning liquid 25 is flown from a supply side to a recovery side. In the immersion lithography apparatus 1, a concentration measuring instrument 30 to monitor a concentration of the cleaning liquid 25 in an immersion liquid is installed at an intermediate position of an immersion liquid recovery tube 37. After cleaning, when the cleaning liquid 25 is replaced with the immersion liquid, the concentration measuring instrument 30 monitors the concentration of the cleaning liquid 25 in the immersion liquid.

Though no figures are shown, at the time of an exposure, in the immersion lithography apparatus 1, a substrate stage 17 is arranged at the exposure position by replacing the cleaning stage 15, and the immersion liquid fills an optical path space between a semiconductor substrate coated with an object of exposure, that is a workpiece, on the substrate stage 17 and the bottom portion of the light projection unit 14. The object of exposure has a photoresist film (hereinafter, referred to as a resist film), or a resist film with a top coat film to protect the resist film, or the like.

The cleaning stage 15 has a reservoir to hold the cleaning liquid 25 by a fence 16 arranged at the circumference of the top surface. The cleaning liquid 25 is supplied from bottom up to the cleaning stage 25 through an opening (not shown, a supply inlet) which opens on the top surface surrounded by the fence 16. The opening of the cleaning stage 15 is connected to a cleaning liquid supply unit 21 through a cleaning liquid supply tube 22. A valve 23 to switch opening and closing of the cleaning liquid 25 is connected at an intermediate position of the cleaning liquid supply tube 22. The cleaning liquid supply unit 21 is provided with a tank to store the cleaning liquid 25, a pressure pump, and a flow controller (not individually shown) and so on, and in case that the cleaning liquid supply tube 22 is comparatively short, the valve 23 is not necessarily required. A cleaning liquid supply system includes the cleaning liquid supply unit 21, the cleaning liquid supply tube 22 and the valve 23.

The cleaning liquid 25 is recovered downward through another opening (not shown, a recovery outlet) which opens on the top surface of the cleaning stage 15 surrounded by the fence 16. The recovery opening of the cleaning stage 15 is connected to a cleaning liquid recovery tube 28. A valve 27 to switch opening and closing is connected at an intermediate position of the cleaning liquid recovery tube 28. In addition, it is possible that the cleaning liquid recovery tube 28 is connected to a cleaning liquid recovery unit provided with a flow controller to control a recovered amount of the cleaning liquid 25 and a suction pump (not individually shown) and so on. A cleaning liquid recovery system includes the valve 27 and the cleaning liquid recovery tube 28.

In the immersion lithography apparatus 1, so as to supply the immersion liquid from the outside of the light projection unit 14, an immersion liquid supply tube 31, an immersion liquid supply unit 32 and a supply nozzle 33 are connected in this order. The immersion liquid supply unit 32 is provided with a tank to store the immersion liquid, a pressure pump and a flow controller (not individually shown) and so on. The supply nozzle 33 is arranged at a position below the bottom portion of the light projection unit 14 where an optical path is not blocked. An immersion liquid supply system includes the immersion liquid supply tube 31, the immersion liquid supply unit 32 and the supply nozzle 33.

At the time of an exposure, the immersion liquid is supplied from the outside to the immersion liquid supply unit 32 through the immersion liquid supply tube 31, and is supplied from the supply nozzle 33 to the optical path space where the semiconductor substrate faces the bottom portion of the light projection unit 14. At the time of a cleaning, the immersion liquid is supplied in the space where the cleaning stage 15 faces the bottom portion of the light projection unit 14 through the same tube as the immersion liquid supply tube 31 at the time of an exposure so as to replace the cleaning liquid.

In the immersion lithography apparatus 1, a recovery nozzle 35, an immersion liquid recovery unit 36 and the immersion liquid recovery tube 37 are connected in this order so as to recover the immersion liquid outside. The immersion liquid recovery unit 36 is provided with a tank to store the immersion liquid, a suction pump and a flow controller (not individually shown) and so on. The recovery nozzle 35 is arranged at a position below the bottom portion of the light projection unit 14 where the optical path is not blocked, and has a configuration to recover the immersion liquid effectively. It is possible to provide enclosures near tips of the supply nozzle 33 and the recovery nozzle 35 or near the supply nozzle 33 and the recovery nozzle 35 so as to hold the immersion liquid in the optical path space on the semiconductor substrate. In addition, valves to switch opening and closing may be provided at an intermediate position of the immersion liquid supply tube 31 and the immersion liquid recovery tube 37, respectively. An immersion liquid recovery system includes the recovery nozzle 35, the immersion liquid recovery unit 36 and the immersion liquid recovery tube 37.

The immersion liquid recovery tube 37 has openings such as an inlet at an upstream position and an outlet at a downstream position, the immersion liquid is introduced from the inlet into the concentration measuring instrument 30, and the immersion liquid which has passed through the concentration measuring instrument 30 is discharged to the outlet. The concentration measuring instrument 30 measures an amount (a concentration) of the cleaning liquid in the immersion liquid and compares the concentration with a specified value.

The light source 11 is an ArF excimer laser (wavelength=193 nm), for example. With respect to forming a circuit pattern, firstly a reticle (not shown) that is a photo mask with a mask pattern is arranged on the reticle stage 13, and a laser light emitted from the light source 11 is collected by the illuminator optical unit 12 and is irradiated on the reticle. The laser light irradiated on the reticle makes an image of the mask pattern on the surface of the object of exposure on the substrate stage 17 through the light projection unit 14, or the mask pattern is transferred onto the resist film (the object of exposure). In addition, the light source 11 may be a KrF excimer laser (wavelength=248 nm) or an F2 laser (wavelength=157 nm).

Though no figures are shown, the reticle stage 13 and the substrate stage 17 may be driven in the horizontal direction. Positions of the reticle stage 13 and the substrate stage 17 are, for example, monitored by laser interferometers respectively and are controlled. The reticle stage 13 and the substrate stage 17 are controlled in a step-and-scan routine or a step-and-repeat routine, for example, and the mask pattern is repeatedly transferred onto the object of exposure.

At the time of an exposure, an immersion liquid layer (a thickness of approximately 100 μm) is formed in the optical path space where the semiconductor substrate faces the bottom portion of the light projection unit 14. It is possible to improve an exposure resolution by exposing while the optical path space is filled with the immersion liquid such as pure water. The immersion lithography apparatus 1 uses pure water with a refractive index of 1.44 in the ArF light source as the immersion liquid, for example. As compared with a dry lithography apparatus where air (refractive index=1) is filled between the light projection unit 14 and the object of exposure, a numerical aperture of the light projection unit 14 becomes substantially 1.44 times, so that it is possible to improve the resolution.

A flow of the immersion liquid is formed so as to prevent the temperature rise at the time of an exposure, and the immersion liquid, while flowing, comes in contact with the semiconductor substrate on which the object of exposure is formed, the bottom portion of the light projection unit 14, the supply nozzle 33, and the recovery nozzle 35 and the like. As a result, contaminants are taken into the immersion liquid mainly from the object of exposure, and the contaminants adhere to the contact regions with the immersion liquid, such as the bottom portion of the light projection unit 14, the supply nozzle 33 and the recovery nozzle 35.

Next, a method for cleaning the contaminants adhering through the immersion liquid of the immersion lithography apparatus 1 will be described. As shown in FIG. 2, after an exposure onto the object of exposure is finished, an immersion liquid under the bottom portion of the light projection unit 14 is recovered from the surface of the object of exposure on the substrate stage 17, the exposed semiconductor substrate is moved to a prescribed position, and the substrate stage 17 is removed (step S11). In addition to removing the substrate stage 17 in the horizontal direction, it is possible to remove the substrate stage 17 to a lower position below the bottom portion of the light projection unit 14 in a state where the substrate stage 17 faces the bottom portion.

The cleaning stage 15 is arranged at a position facing the bottom portion of the light projection unit 14 (step S12). A distance between the bottom portion of the light projection unit 14 and the object of exposure is kept to be about 100 μm, for example, a distance between the bottom portion of the light projection unit 14 and a top face of the cleaning stage 15 may be larger than about 100 μm.

The cleaning liquid 25 is supplied in the reservoir surrounded by the fence 16 on the top face of the cleaning stage 15, until the cleaning liquid 25 contains at least the contact regions such as the bottom portion of the light projection unit 14, the supply nozzle 33, and the recovery nozzle 35 and the like, where the immersion liquid has contacted to. A definite quantity of the cleaning liquid 25 is held in the reservoir, and the contact regions to the immersion liquid is cleaned while the cleaning liquid 25 is poured, and is controlled by a flow rate or a supply time or the like of the cleaning liquid 25 (step S13).

In order to fill the cleaning liquid 25 until including the contact regions to the immersion liquid, it is favorable to detect a surface position of the cleaning liquid 25. The cleaning liquid 25 is supplied from the supply inlet of the cleaning stage 15 and is recovered from the recovery outlet, so that a flow is formed. The flow rate or the supply time or the like of the cleaning liquid 25 is decided based on a kind of the object of exposure on the semiconductor substrate and the number of the substrates which have just processed, for example.

The cleaning liquid 25 is an alkaline solution including tetramethylammonium hydroxide (TMAH), for example. TMAH is used in many cases by a concentration of 2.38 wt % or lower, for example, and the concentration of the TMAH in the cleaning liquid 25 may be at most 2.38 wt %. In addition, with respect to the cleaning liquid 25, a solution including a solvent of an ether system may be used such as diethylene glycol monobutyl ether and the like, and a solution including a solvent of an alcohol system may be used such as isopropyl alcohol and the like.

Supply of the cleaning liquid 25 is stopped, and the cleaning liquid 25 is recovered from the reservoir of the cleaning stage 15 (step S14). The valve 23 of the cleaning liquid supply tube 22 is closed, and after the cleaning liquid 25 has been recovered, the valve 27 of the cleaning liquid recovery tube 28 is closed.

The pure water (immersion liquid) is supplied from the immersion supply unit 32 to the reservoir of the cleaning stage 15, and recovering the pure water from the immersion liquid recovery unit 36 is started so that the pure water does not overflow from the reservoir, and the cleaning liquid 25 is replaced with the immersion liquid (step S15). The immersion liquid is poured until the immersion liquid contains at least the contact regions to which the cleaning liquid 25 has contacted. It is favorable to detect the surface position of the immersion liquid. In addition, when the cleaning liquid 25 is replaced with the immersion liquid, a part of the cleaning liquid 25 is recovered through the cleaning liquid recovery tube 28, and a part of the immersion liquid is recovered from a recovery valve (not shown) which is provided just before the valve 23 of the cleaning liquid supply tube 22 at the cleaning stage 15 side, and thereby it is possible to reduce a bad effect of the replacement of the cleaning liquid 25 with the immersion liquid.

The concentration of the cleaning liquid 25 in the immersion liquid is measured with the concentration measuring instrument 30, and the measured concentration is compared with the specified value set beforehand (step S16). In case that the measured concentration is more than the specified value, the concentration is judged as NG at the step S16 as the cleaning liquid 25 remains in the immersion liquid, and the process to replace the cleaning liquid 25 with the immersion liquid is continued. On the other hand, in case that the measured concentration is not more than the specified value, the concentration is judged as OK because the concentration of the cleaning liquid 25 is reduced to an extent that the immersion liquid is useable for the immersion liquid, and the method is advanced to a next process.

The specified concentration value of the cleaning liquid 25 in the immersion liquid is set based on a kind of the object of exposure on the semiconductor substrate which will be next exposed, such as a kind of the films which may come in contact with the immersion liquid, and so on. In case of using TMAH as the cleaning liquid 25, it is possible to use a commercially available measuring instrument, with respect to the concentration measuring instrument 30, such as HE-960H-TM (HORIBA, Ltd) and the like which measures an electric conductivity and converts the electric conductivity into a concentration. In addition, in case of diethylene glycol monobutyl ether, isopropyl alcohol and the like, it is possible that chemical and physical properties of each solvent such as a refractive index and the like are measured and are converted into concentrations.

The immersion liquid supplied to the reservoir of the cleaning stage 15 is stopped, and after the immersion liquid has recovered from the reservoir, the cleaning stage 15 is removed from the position facing the bottom portion of the light projection unit 14 (step S17). The immersion liquid in the reservoir may not be necessarily recovered completely.

The semiconductor substrate is loaded on a prescribed position of the substrate stage 17, and the substrate stage 17 is arranged at the position facing the bottom portion of the light projecting unit 14 (step S18). As the cleaning stage 15 has been removed to the position where a well-known exposure process is not disturbed, it is possible to perform the well-known subsequent exposure process by arranging the substrate stage 17 at the exposure position,

As described above, the immersion lithography apparatus 1 includes the cleaning stage 15 which the cleaning liquid supply tube 22 and the cleaning liquid recovery tube 28 are connected to and can clean the contact regions to the immersion liquid, and the concentration measuring instrument 30 which can monitor the concentration of the cleaning liquid 25 in the immersion liquid after cleaning is provided on the immersion liquid recovery tube 37. The immersion lithography apparatus 1 can perform sufficient replacement until the concentration of the cleaning liquid 25 is reduced to the specified value. Compared with a method for controlling the replacement of the cleaning liquid by the time and so on, it becomes possible to suppress a bad effect of the remaining cleaning liquid which gives to the object of exposure and the semiconductor substrate and so on such that the semiconductor substrate is etched excessively, as it is possible to reduce certainly the concentration of the cleaning liquid 25 in the immersion liquid to the specified value or less in a more appropriate time such as in a shorter time. That is, the immersion lithography apparatus 1 minimizes the replacement time of the cleaning liquid with the immersion liquid, and it is possible to suppress the reduction of the yield in the manufacturing process.

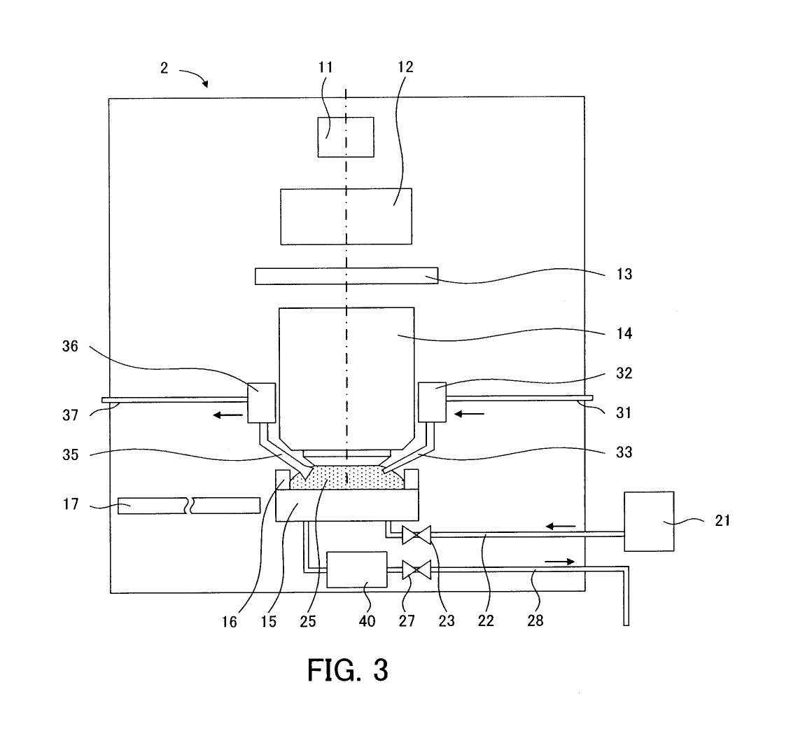

An immersion lithography apparatus and a method for cleaning an immersion lithography apparatus according to a second embodiment of the invention will be described with reference to FIG. 3. The difference from the immersion lithography apparatus 1 of the first embodiment is that a concentration measuring device is provided at an intermediate position of the cleaning liquid recovery tube. In addition, the same reference numerals are given for the same components of the first embodiment, and the description will be omitted.

As shown in FIG. 3, in an immersion lithography apparatus 2, being different from the first embodiment, a concentration measuring instrument 40 similar to the concentration measuring instrument 30 is provided at the intermediate position of the cleaning liquid recovery tube 28 between the cleaning stage 15 and the valve 27, for example. The other components are the same as those of the immersion lithography apparatus 1.

As a result that the concentration measuring instrument 40 is provided at an intermediate position of the cleaning liquid recovery tube 28, the recovery route of the replacement of the cleaning liquid with the immersion liquid differs from that of the first embodiment. That is, the immersion liquid supplied from the immersion liquid supply unit 32 is recovered from that of the reservoir of the cleaning stage 15 through the cleaning liquid recovery tube 28. The concentration measurement of the cleaning liquid 25 in the concentration measuring instrument 40 is performed in the same manner as in the concentration measuring instrument 30 of the first embodiment. At a time when the concentration of the cleaning liquid 25 in the immersion liquid becomes not more than a specified value, the replacement with the immersion liquid is finished. And as the concentration measuring instrument 40 is removed together with the cleaning stage 15, the concentration measuring instrument 40 does not interfere with an arrangement of the substrate stage 17 at the position facing the bottom of the light projection unit 14.

The immersion lithography apparatus 2 has similarly effects which the immersion lithography apparatus 1 has. In the immersion lithography apparatus 2, as the concentration measuring instrument 40 is provided at the intermediate position of the cleaning liquid recovery tube 28, it is possible to manufacture and fit the concentration measuring device 40 as a system different from the supply system and the recovery system of the immersion liquid. As a result, it is possible to form relatively easily the immersion lithography apparatus 2 by adding a cleaning liquid supply system and a cleaning liquid recovery system to an immersion lithography apparatus without a cleaning stage provided with a concentration measuring instrument.

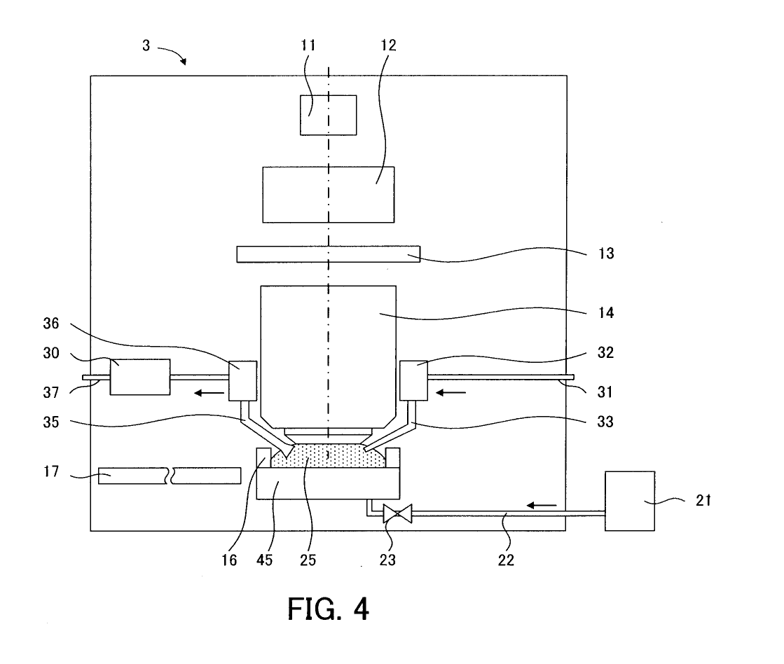

An immersion lithography apparatus and a method for cleaning an immersion lithography apparatus according to a third embodiment of the invention will be described with reference to FIG. 4. The difference from the immersion lithography apparatus 1 of the first embodiment is that an immersion liquid recovery tube serves as a cleaning liquid recovery tube. In addition, the same reference numerals are given for the same components of the first and second embodiments, and the description will be omitted.

As shown in FIG. 4, an immersion lithography apparatus 3, does not have a recovery tube only for a cleaning liquid, being different from the immersion lithography apparatus 1. In the immersion lithography apparatus 3, a cleaning stage 45 is arranged by replacing the cleaning stage 15 of the immersion lithography apparatus 1, and the cleaning stage 45 is connected to the cleaning liquid supply unit 21 through the cleaning liquid supply tube 22. A configuration is used that the cleaning liquid 25 on the cleaning stage 45 is recovered through the immersion liquid recovery tube 37. That is, the immersion liquid recovery system is also the cleaning liquid recovery system. The other components are the same as those of the immersion lithography apparatus 1.

As a result that the recovery tube only for the cleaning liquid is omitted, the recovery route of the cleaning liquid 25 differs from that of the first embodiment. That is, the cleaning liquid 25 supplied from the cleaning liquid supply unit 21 to the cleaning stage 45 is recovered from the reservoir of the cleaning stage 45 through the immersion liquid recovery tube 37. After cleaning, the replacement of the cleaning liquid 25 with the immersion liquid is the same as in the immersion lithography apparatus 1, and a measurement with the concentration measuring instrument 30 and the comparison of the measured concentration with the specified value set beforehand are the same.

The immersion lithography apparatus 3 has similarly effects which the immersion lithography apparatus 1 has. In the immersion lithography apparatus 3, as a result that the cleaning liquid recovery system such as the cleaning liquid recovery tube and so on only for the cleaning liquid recovery are omitted, a space around the cleaning stage 45 and so on increases, and installations and removals of the cleaning stage 45 become easier.

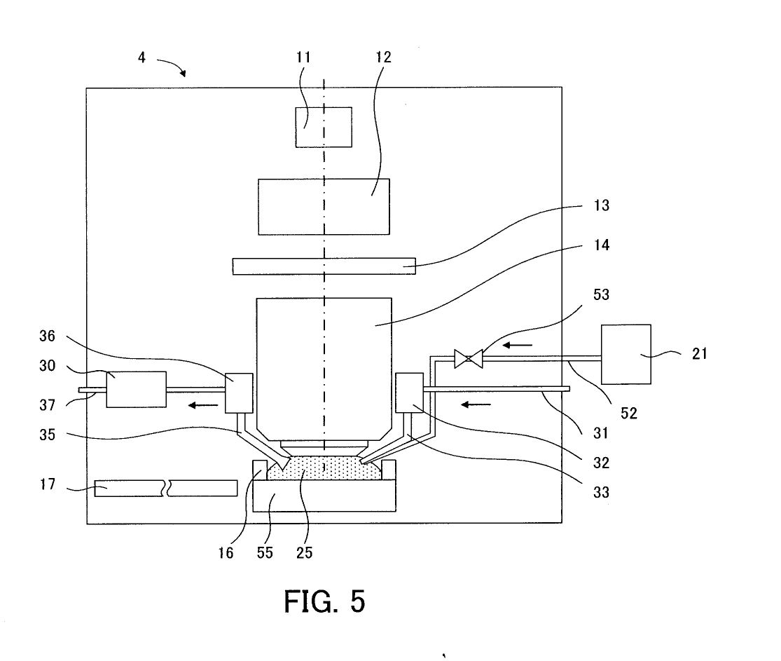

An immersion lithography apparatus and a method for cleaning an immersion lithography apparatus according to a fourth embodiment of the invention will be described with reference to FIG. 5. The difference from the immersion lithography apparatus 3 of the third embodiment is that a cleaning liquid supply is performed from an upper part of the cleaning stage in the same manner as an immersion liquid supply. In addition, the same reference numerals are given for the same components of the first through third embodiments, and the description will be omitted.

As shown in FIG. 5, in an immersion lithography apparatus 4, a supply opening of a cleaning liquid supply tube 52 is arranged above a cleaning stage 55 at a position like the supply nozzle 33 of the immersion liquid, being different from the immersion lithography apparatus 3. In the immersion lithography apparatus 4, the cleaning stage 55 is arranged by replacing the cleaning stage 45 of the immersion lithography apparatus 3, and the cleaning liquid supply tube 52 is not directly connected to the cleaning stage 55. That is, the supply opening of the cleaning liquid supply tube 52 connected to the cleaning liquid supply unit 21 is arranged separately from the cleaning stage 55. In addition, the supply opening of the cleaning liquid supply tube 52 may be arranged to such an extent that the cleaning stage 55 is contacted. A cleaning liquid supply system includes the cleaning liquid supply unit 21, the cleaning liquid supply tube 52 and a valve 53.

The valve 53 is arranged at an intermediate position of the cleaning liquid supply tube 52, but in case that the cleaning liquid supply tube 52 is shorter, the valve 53 may be omitted. In addition, it is possible to supply the cleaning liquid 25 through the supply nozzle 33 of the immersion liquid, and in such the case, the cleaning liquid supply tube 52 is connected to the supply nozzle 33 and the removal of cleaning liquid supply tube 52 is not required at the time of exposure. The other components are the same as those of the immersion lithography apparatus 3.

A cleaning liquid supply tube and a cleaning liquid recovery tube are not connected to the cleaning stage 55, and, the supply and recovery routes of the cleaning liquid 25 are similar to those of the immersion liquid. That is, the cleaning liquid supplied from the cleaning liquid supply unit 21 to the cleaning stage 55 through the cleaning liquid supply tube 52 is recovered from the reservoir of the cleaning stage 55 through the immersion liquid recovery tube 37. After cleaning, the replacement of the cleaning liquid 25 with the immersion liquid is the same as in the immersion lithography apparatus 1, and the measurement with the concentration measuring instrument 30 and to compare the measured concentration with the specified value set beforehand are the same. At the time of a replacement of the cleaning liquid 25 with the immersion liquid and an exposure, the cleaning liquid supply tube 52 may be removed so as not to contact with the immersion liquid. In addition, if the supply opening of the cleaning liquid supply tube 52 is arranged at a position not to contact with the immersion liquid, the removal of the cleaning liquid supply tube 52 is not necessarily required.

The immersion lithography apparatus 4 has similarly effects which the immersion lithography apparatus 3 has. In the immersion lithography apparatus 4, as a result that a connection of the cleaning liquid supply tube with the cleaning stage 55 is omitted, a space around the cleaning stage 55 increases more, and installations and removals of the cleaning stage 55 are much easier.

As a modification of the fourth embodiment, in the immersion lithography apparatus 4, it is possible to use a configuration that the cleaning liquid recovery tube 28 and the valve 27 provided in the cleaning stage 15 of the immersion lithography apparatus 1 are connected to the cleaning stage 55. In addition, in the immersion lithography apparatus 4, it is possible to use a configuration that the cleaning liquid recovery tube 28, the valve 27 and the concentration measuring instrument 40 provided in the cleaning stage 15 of the immersion lithography apparatus 2 are connected to the cleaning stage 55.

While certain embodiments have been described, these embodiments have been presented by way of example only, and are not intended to limit the scope of the inventions. Indeed, the novel apparatuses and methods described herein may be embodied in a variety of other forms; furthermore, various omissions, substitutions and changes in the form of the apparatuses and methods described herein may be made without departing from the spirit of the inventions. The accompanying claims and their equivalents are intended to cover such forms or modifications as would fall within the scope and spirit of the inventions.

In the embodiments, an example was shown that the immersion liquid is pure water and the cleaning liquid is replaced with the pure water, for example, but a case can be used that the immersion liquid is liquid having a refractive index appropriate for exposure except the pure water and the cleaning liquid is replaced with the immersion liquid. In addition, a case can be used that the pure water is supplied from the immersion liquid supply nozzle to replace only when the cleaning liquid is replaced.

In addition, an example was shown that the substrate is the semiconductor substrate, but it is possible that the substrate is a glass substrate, a dielectric crystal substrate, a plastic substrate, or a metal plate or the like.

What is claimed is:

1. An immersion lithography apparatus comprising:
a substrate stage that holds a workpiece, the substrate stage being configured to be possible to take an exposure position under a bottom portion of a light projection unit in a vertical direction and to keep away from the exposure position under the light projection unit;
a cleaning stage having a reservoir of a cleaning liquid or an immersion liquid in a top portion, the cleaning stage being configured to be possible to take the exposure position by replacing the substrate stage and to keep away from the exposure position;
an immersion liquid supply system and an immersion liquid recovery system, the immersion liquid supply system supplying the immersion liquid between the bottom portion of the light projection unit and the workpiece or in the reservoir, the immersion liquid recovery system recovering the immersion liquid;
a cleaning liquid supply system and a cleaning liquid recovery system, the cleaning liquid supply system supplying the cleaning liquid in the reservoir to include contact regions to the immersion liquid, the cleaning liquid recovery system recovering the cleaning liquid; and
a concentration measuring instrument installed on the immersion liquid recovery system or the cleaning liquid recovery system, the concentration measuring instrument measuring a concentration of the cleaning liquid in the immersion liquid.

2. The immersion lithography apparatus according to claim 1, wherein the cleaning liquid includes one of tetramethylammonium hydroxide, diethylene glycol monobutyl ether, and isopropyl alcohol.

3. The immersion lithography apparatus according to claim 2, wherein the concentration measuring instrument has a conversion function of a measured electric conductivity to the concentration or a conversion function of a measured refractive index to the concentration.

4. The immersion lithography apparatus according to claim 1, wherein the cleaning liquid supply system and the cleaning liquid recovery system are connected to the cleaning stage.

5. The immersion lithography apparatus according to claim 4, wherein the concentration measuring instrument is installed on the cleaning liquid recovery system.

6. An immersion lithography apparatus comprising:
a substrate stage that holds a workpiece, the substrate stage being configured to be possible to take an exposure position under a bottom portion of a light projection unit in a vertical direction and to keep away from the exposure position under the light projection unit;
a cleaning stage having a reservoir of a cleaning liquid or an immersion liquid in a top portion, the cleaning stage being configured to be possible to take the exposure position by replacing the substrate stage and to keep away from the exposure position;
an immersion liquid supply system and an immersion liquid recovery system, the immersion liquid supply system supplying the immersion liquid between the bottom portion of the light projection unit and the workpiece or in the reservoir, the immersion liquid recovery system recovering the immersion liquid;
a cleaning liquid supply system and a cleaning liquid recovery system, the cleaning liquid supply system supplying the cleaning liquid in the reservoir to include contact regions to the immersion liquid, the cleaning liquid recovery system being the immersion liquid recovery system recovering the cleaning liquid; and
a concentration measuring instrument installed on the immersion liquid recovery system, the concentration measuring instrument measuring a concentration of the cleaning liquid in the immersion liquid.

7. The immersion lithography apparatus according to claim 6, wherein the cleaning liquid includes one of tetramethylammonium hydroxide, diethylene glycol monobutyl ether, and isopropyl alcohol.

8. The immersion lithography apparatus according to claim 7, wherein the concentration measuring instrument has a conversion function of a measured electric conductivity to the concentration or a conversion function of a measured refractive index to the concentration.

9. The immersion lithography apparatus according to claim 6, wherein the cleaning liquid supply system is connected to the cleaning stage.

10. The immersion lithography apparatus according to claim 6, wherein the cleaning liquid supply system has a supply opening above the reservoir.

11. A method for cleaning an immersion lithography apparatus comprising:
removing a substrate stage from an exposure position under a bottom portion of a light projection unit after exposing a workpiece between the light projection unit and the substrate stage through an immersion liquid;
arranging a cleaning stage in a cleaning position under the bottom portion of the light projection unit in a vertical direction and cleaning contact regions to the immersion liquid with a cleaning liquid running from a supply opening to a recovery opening on a reservoir in a top portion of the cleaning stage, the reservoir being supplied with the cleaning liquid to an extent that the contact regions is covered;
measuring a concentration of the cleaning liquid in the immersion liquid or a water while the cleaning liquid is replaced with the immersion liquid or the water after the cleaning liquid is stopped, and lowering the concentration to less than or equal to a specified value; and
stopping supplying the immersion liquid or the water after the concentration is lowered to less than or equal to the specified value and removing the cleaning stage from the cleaning position.

12. The method according to claim 11, wherein the supply opening and the recovery opening for the cleaning liquid are provided on the cleaning stage.

13. The method according to claim 12, wherein measuring the concentration of the cleaning liquid in the immersion liquid or the water is performed by a concentration measuring instrument having an inlet on a immersion liquid recovery tube.

14. The method according to claim 12, wherein measuring the concentration of the cleaning liquid in the immersion liquid or the water is performed by a concentration measuring instrument having an inlet on a cleaning liquid recovery tube.

15. The method according to claim 11, wherein the supply opening for the cleaning liquid is provided on the cleaning stage.

16. The method according to claim 15, wherein measuring the concentration of the cleaning liquid in the immersion liquid or the water is performed by a concentration measuring instrument having an inlet on a recovery tube for both the cleaning liquid and the immersion liquid.

17. The method according to claim 11, wherein the supply opening for the cleaning liquid is provided outside the cleaning stage.

18. The method according to claim 17, wherein measuring the concentration of the cleaning liquid in the immersion liquid or the water is performed by a concentration measuring instrument having an inlet on a recovery tube for both the cleaning liquid and the immersion liquid.

19. The method according to claim 11, wherein the cleaning liquid includes one of tetramethylammonium hydroxide, diethylene glycol monobutyl ether, and isopropyl alcohol.

20. The method according to claim 19, wherein the concentration of the cleaning liquid in the immersion liquid or the water is determined by converting a measured electric conductivity or a measured refractive index.
